(19) United States
(12) Patent Application Publication
(10) Pub. No.: US 2005/0067829 A1
(43) Pub. Date: Mar. 31, 2005

(54) Customized cover for binders, folders and portfolios

(76) Inventor: Wanda Mally, Falls Church, VA (US)

Correspondence Address: LITMAN LAW OFFICES, LTD., P.O. BOX 15035 CRYSTAL CITY STATION, ARLINGTON, VA, 22215, US

(21) Appl. No.: 10/669,431

(22) Filed: Sep. 25, 2003

(51) Int. Cl. B42D 3/00

(52) U.S. Cl. 281/29

(57) ABSTRACT

A customized cover for generic binders, folders and portfolios, which cover is adapted to change the exterior appearance of the aforementioned items. A user can essentially own a single binder, or the like, but can easily change the binder's exterior appearance simply by changing the cover. The covers are uniquely decorated and are made from different fabric types so that a user can select a cover to correspond with the aesthetics of the occasion. The fabric can also be water repellant if desired.

### BACKGROUND OF THE INVENTION

1. Field of the Invention

The present invention generally relates to protective coverings. More specifically, the present invention is drawn to customized, removable, fashion covers for binders, folders and/or portfolios.

2. Description of the Related Art

Notebooks and the like, which are subjected to heavy use, can become worn and bedraggled. The unsightliness of such notebooks tends to distract from one's fashion aura. The related art is rife with attempts to remedy the above stated situation.

For example, U.S. Pat. Nos. Des. 292,597 (Gifford et al.), Des. 295,538 (Stajan et al.), Des. 393,874 (Hodes) and 394,453 (Allen et al.) are drawn to books having ornamental designs on the covers thereof. There is no indication that the covers are removable and no structure is shown that would secure the covers in closed position.

U.S. Pat. No. 4,819,964 (Dupuis) discloses a removable book cover, which cover requires adhesive-coated tapes to secure the cover to the book. The patentee does not contemplate customizing the cover or securing the cover in closed position.

A stuffed toy figurine, adapted for use as a removable cover is shown in U.S. Pat. No. 4,832,648 (Theobald et al.). Although ornamental, the cover does not have structure for securing the book in a closed position.

U.S. Pat. No. 4,886,299 (Ducorday) contemplates a book cover fabricated from transparent plastic material. The patentee is not concerned with customization or securing the cover in a closed position.

Elastic book covers are the subject matter of U.S. Pat. No. 5,013,068 (Maldonado), U.S. Pat. No. 5,158,325 (Landis et al.) and U.S. Pat. No. 5,470,109 (Grande). Neither of the patentees shows ornamental decorations or cover securing means.

U.S. Pat. No. 5,219,437 (Moor et al.) and U.S. Pat. No. 6,257,622 (Peker) disclose book covers made from fabric. There is no disclosure that would indicate that the fabric is removable or that the patentees intend to provide customized ornamentation to the cover.

None of the above inventions and patents, taken either singly or in combination, is seen to disclose a customized cover for binders, folders and portfolios as will be subsequently described and claimed in the instant invention.

### SUMMARY OF THE INVENTION

The instant invention is a customized cover for generic binders, folders and portfolios, which cover is adapted to change the exterior appearance of the aforementioned items. A user can essentially own one binder, or the like, but can easily change the binder's exterior appearance simply by changing the cover. The covers are uniquely decorated and are made from different fabric types so that a user can select a cover to correspond with the aesthetics of the occasion. The fabric can also be water repellant and/or stain resistant if desired. Decorations may include, but are not limited to, new, repurposed, recycled, and/or discontinued computer-related components; hand-sewn designs; sewn-on designs using other repurposed or recycled objects. It is obvious that the covers can also be made available without decorations. The sizes of the covers will vary to fit all conventional binders, folders and portfolios.

The invention enables the user to change and/or customize the look of the binder, folder or portfolio instead of buying quantities of the stated items.

Accordingly, it is a principal object of the invention to provide a decorative, customized cover for a binder, folder or portfolio.

It is another object of the invention to provide a decorative, customized cover for a binder, folder or portfolio, which cover is easily removable.

It is a further object of the invention to provide a decorative, customized cover for a binder, folder or portfolio, which cover can be exchanged with other decorative covers.

Still another object of the invention is to provide a decorative, customized cover for a binder, folder or portfolio, which cover is made from fabric.

It is an object of the invention to provide improved elements and arrangements thereof for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a first embodiment of a customized cover for binders, folders and portfolios according to the present invention.

FIG. 2 is an environmental plan view of a first embodiment of a customized cover for binders, folders and portfolios according to the present invention.

FIG. 3 is an environmental, perspective view of a second embodiment of a customized cover for binders, folders and portfolios according to the present invention.

FIG. 4 is a plan view of a second embodiment of a customized cover for binders, folders and portfolios according to the present invention.

FIG. 5 is a front view of a second embodiment of a customized cover for binders, folders and portfolios according to the present invention.

FIG. 6 is a rear view of a second embodiment of a customized cover for binders, folders and portfolios according to the present invention.

FIG. 7 is a perspective view of a third embodiment of a customized cover for binders, folders and portfolios according to the present invention.

Similar reference characters denote corresponding features consistently throughout the attached drawings.

### DETAILED DESCRIPTION OF THE PREFERRED EMBODIMENTS

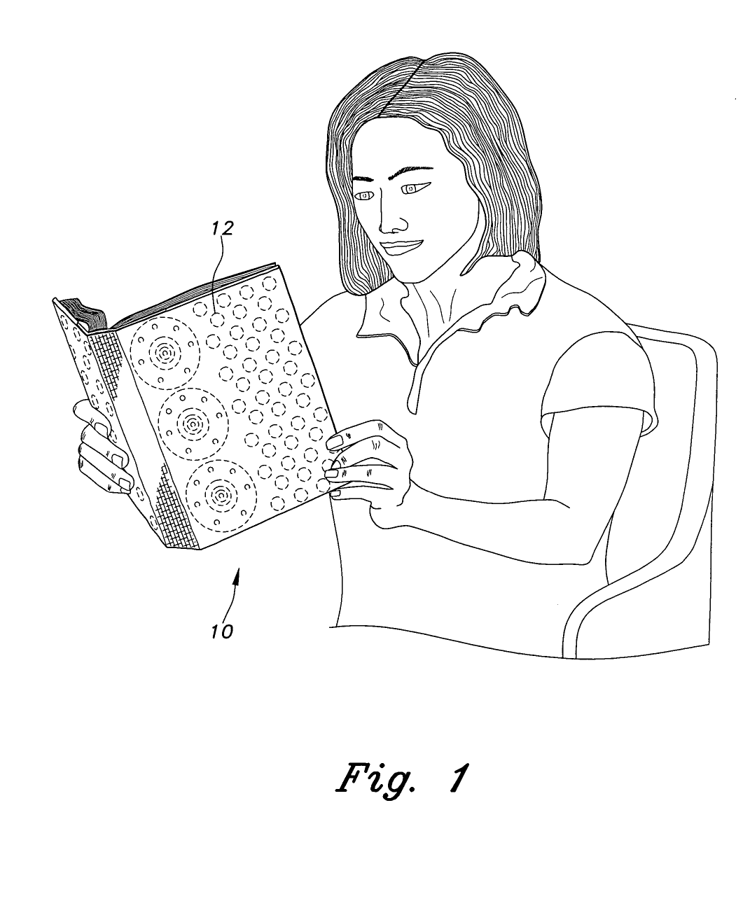

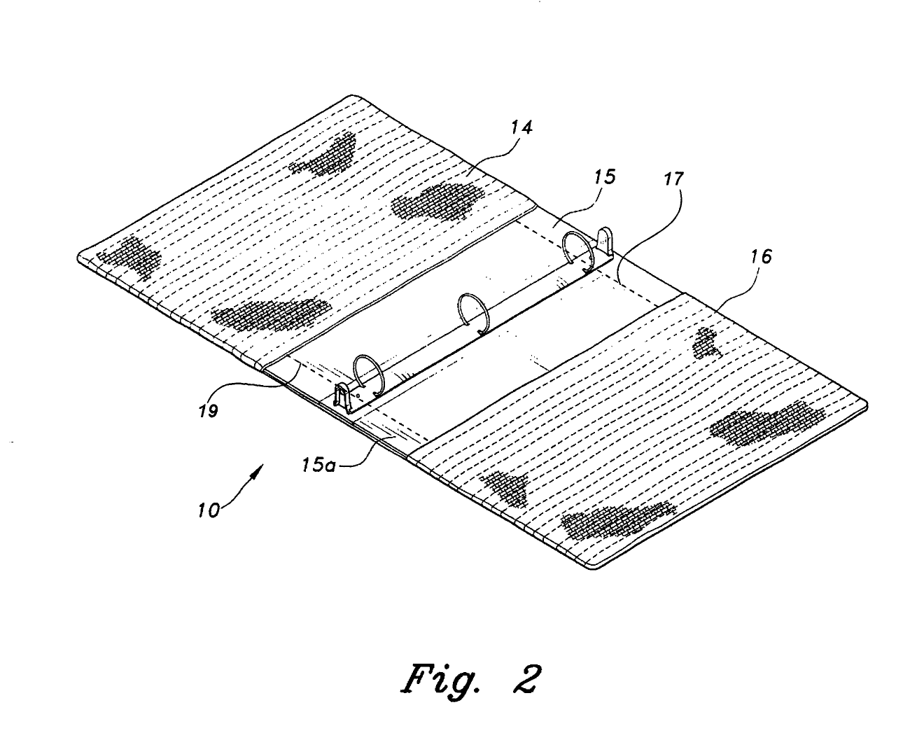

Attention is first directed to FIGS. 1 and 2 wherein a first embodiment of a customized cover of the instant invention is generally indicated at 10. As illustrated the exterior surface 12 of the cover is continuous and is decorated with recycled CDs. It is to be noted however, that any decorative object(s) or design(s) may be utilized. The objects or designs may be attached to the exterior surfaces by any expedient method (sewing, hook-and-loop, glue, etc.). The decorative objects may be disposed on both or only one exterior surface as desired. The interior of the customized cover 10 is lined and is comprised of opposed pockets 14, 16, which pockets are adapted to receive the front and rear covers 15, 15a of a binder, folder or portfolio. Exterior surface 12 and pockets 14, 16 are constructed from fabric, which fabric may be washable. The fabric cover and lining may be of any desired color or pattern. As contemplated, the exterior surface is lined. Also the pockets will be doubled and therefore lined. All hems or edges will be reinforced (double-stitched) to present a durable and shape-retaining cover. A pair of webbing straps 17, 19 (shown in phantom lines) are attached to the inner surface of the cover and disposed to support and reinforce the folded-in edges of the cover. The straps also function to cover exposed stitching from the inside lining. Webbing straps 17, 19 are fabricated from non-stretchable fabric tape. As noted above, the customized covers will be made in different sizes to accommodate conventional sized binders, folders and portfolios.

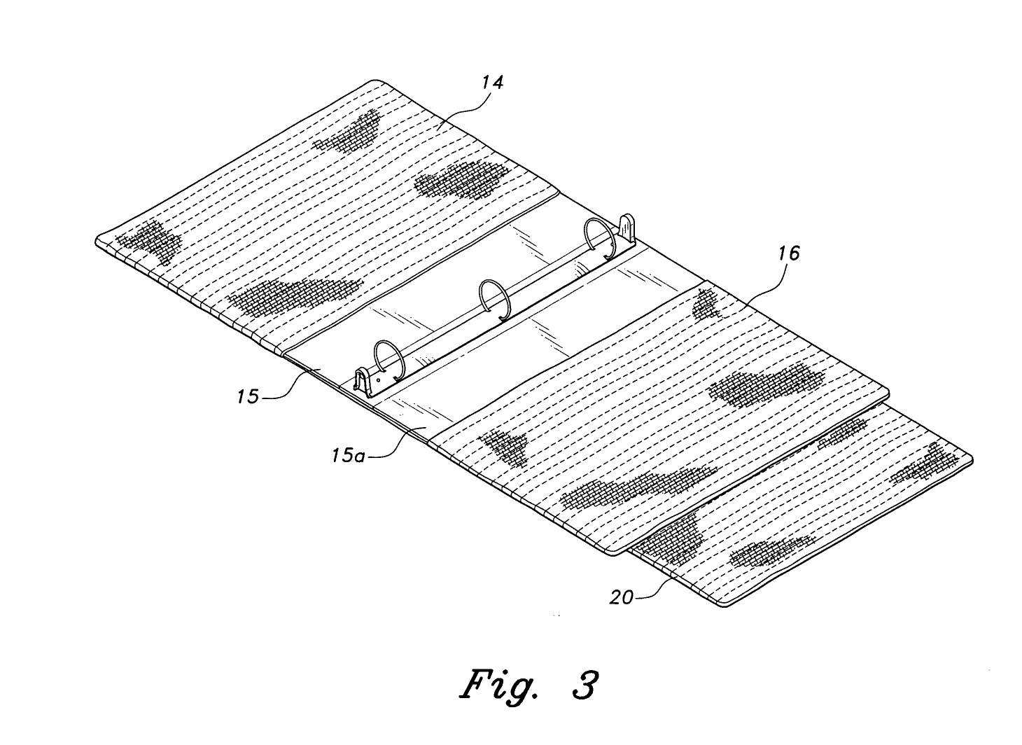

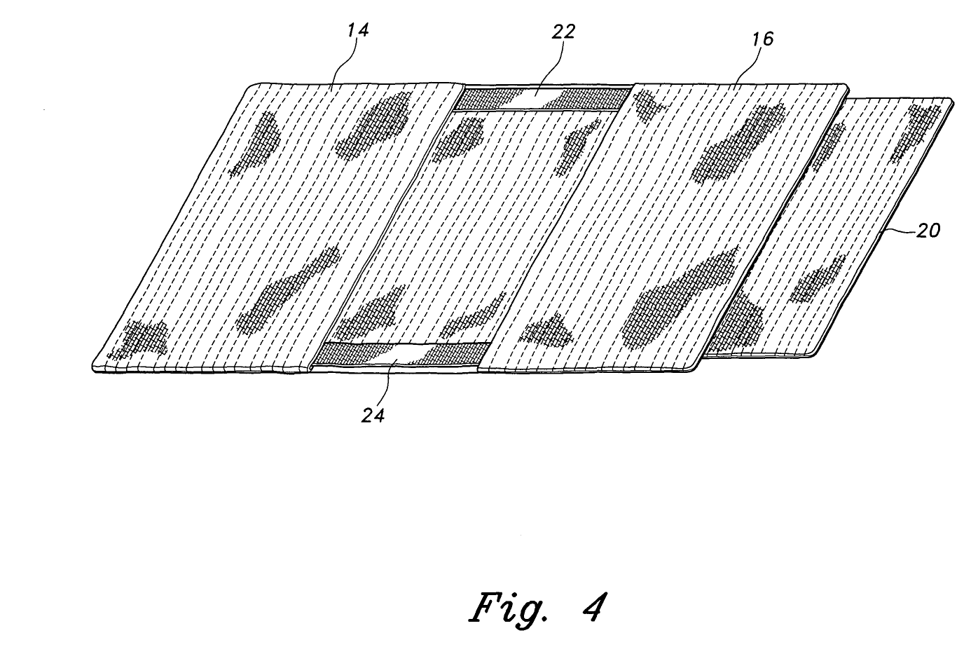

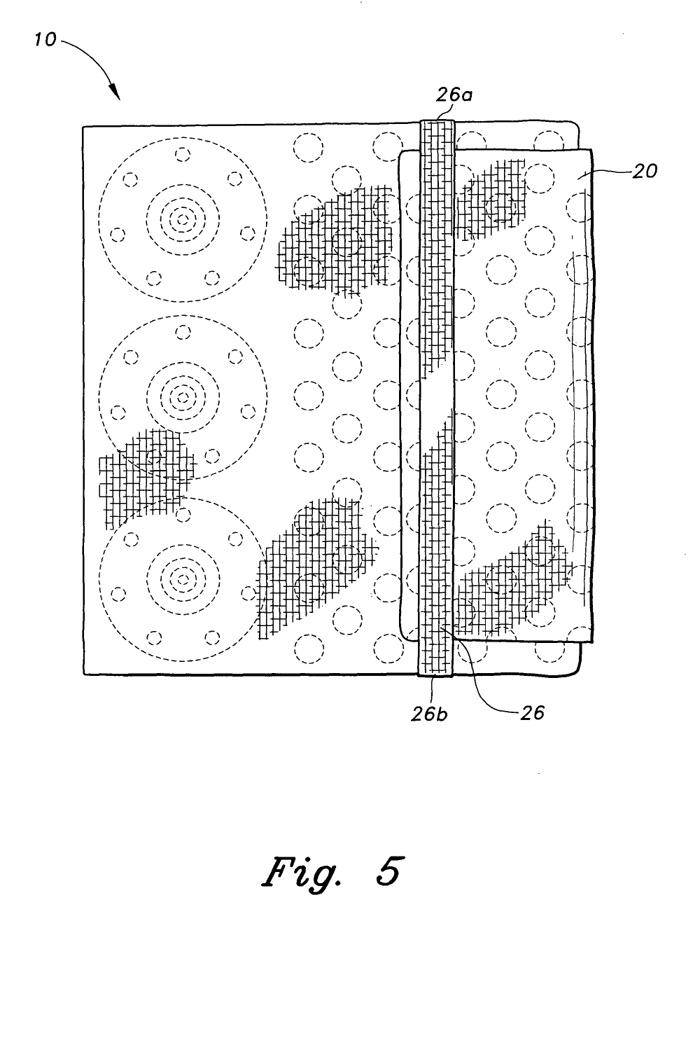

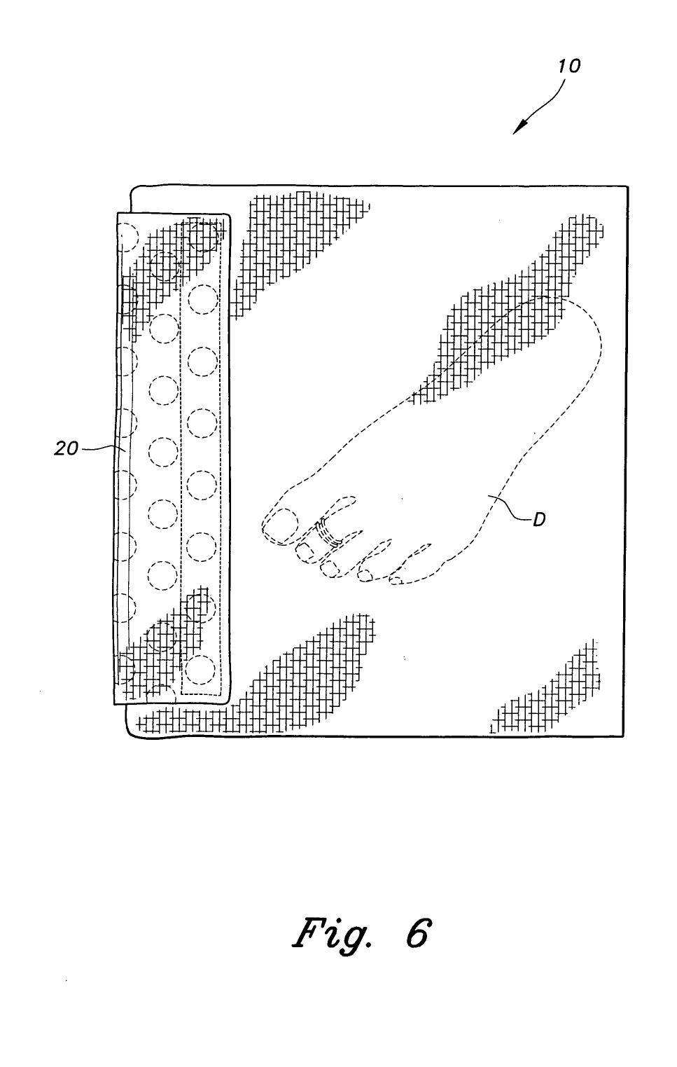

As illustrated in FIGS. 3-6, a second embodiment of the invention incorporates means for securing the binder, folder or portfolio in a closed position. The means includes a flap 20, which flap extends from one edge of cover 10. The flap extends outwardly from the edge a distance depending on the overall size of the cover. The flap is lined with cotton batting. As best seen in FIG. 4, a pair of webbing straps 22, 24 are attached to the inner surface of the cover. The webbing straps 22,24 perform the same function and are fabricated from the same material as the webbing straps 17, 19 disclosed above. As best seen in FIG. 5, a securing strap 26 is attached to span the exterior front surface of cover 10. Each end 26a and 26b is attached between the seams at each side of the cover. Strap 26 functions to retain flap 20 therein when the binder, folder or portfolio is in closed position. To this end, the length of the flap 20 is such that it can be tucked under the securing strap 26. The above arrangement affords a bit of security in that loose papers are prevented from falling out if the binder, folder or portfolio is turned upside down. The inside of securing strap 26 consists of a stiff felt so that the strap will hold its shape. A customized decorative object or design D may be disposed on the rear exterior surface of the customized cover 10 (FIG. 6). As in the first embodiment, the embodiment illustrated in FIGS. 3-6 will be made of fabric of any desired color and/or pattern.

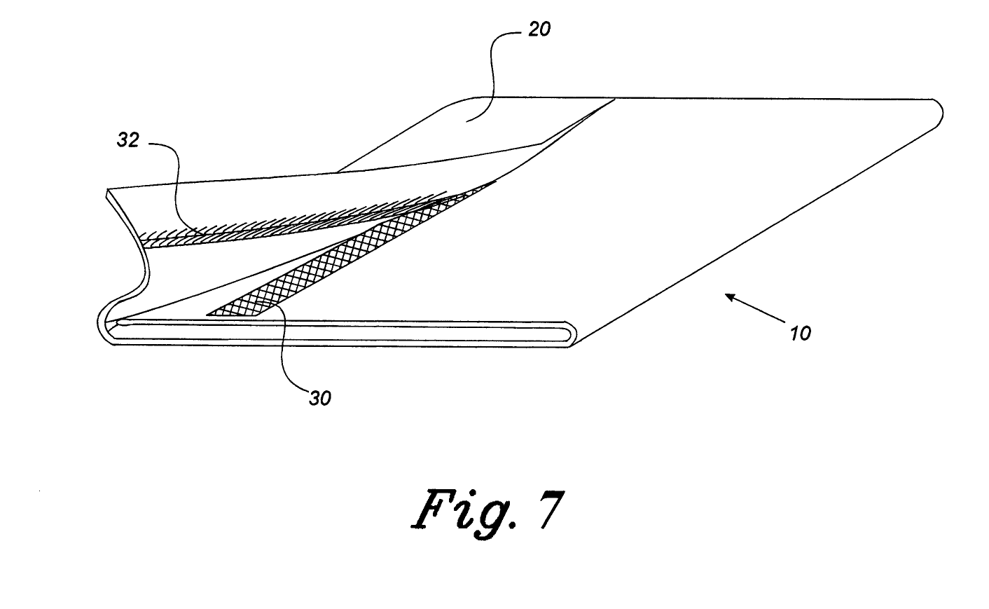

The embodiment of FIG. 7 presents an alternative arrangement in that no securing strap is utilized. As shown, hook and loop fasteners 30 and 32 are employed to secure flap 20 to the front surface of cover 10. The hook and loop fasteners extend nearly the lengths of the respective flap and front surface.

It is to be understood that the present invention is not limited to the embodiments described above, but encompasses any and all embodiments within the scope of the following claims.

1. A customized cover for binders, folders and portfolios, comprising:
a lined cover having a continuous exterior surface and a continuous interior surface, said cover having a first end and a second end;
a first pocket disposed on said interior surface, said first pocket positioned adjacent said first end;
a second pocket spaced from said first pocket and disposed on said interior surface, said second pocket positioned adjacent said second end;
wherein said first pocket and said second pocket have opposite sides and including a pair of webbing straps attached to the interior surface of the cover and disposed to provide reinforcement and to disguise stitching; and
decorative designs disposed on said exterior surface.

2. The customized cover for binders, folders and portfolios as recited in claim 1, wherein the cover is constructed from fabric.

3. The customized cover for binders, folders and portfolios as recited in claim 2, wherein the fabric is made from water repellant material.

4. A customized cover for binders, folders, and portfolios comprising:
a lined fabric cover having a continuous exterior surface and a continuous interior surface, said cover having a first end and a second end;
a first pocket disposed on said interior surface, said first pocket positioned adjacent said first end;
a second pocket spaced from said first pocket and disposed on said interior surface, said second pocket positioned adjacent said second end;
means to secure said cover in a closed position; and
decorative designs disposed on and affixed to said exterior surface.

5. The customized cover for binders, folders and portfolios as recited in claim 4, wherein said first pocket and said second pocket have opposite sides and including a pair of webbing straps attached to the interior surface of the cover and disposed to provide reinforcement and to disguise stitching.

6. The customized cover for binders, folders and portfolios as recited in claim 5, wherein said pair of webbing straps is fabricated from non-stretchable fabric tape.

7. The customized cover for binders, folders and portfolios as recited in claim 4, wherein said cover has a front exterior surface and wherein said means to secure includes a securing strap attached to and spanning said front exterior surface.

8. The customized cover for binders, folders and portfolios as recited in claim 7, wherein said securing strap has a length extending between opposite ends and wherein said securing strap is attached to said exterior surface at said opposite ends.

9. The customized cover for binders, folders and portfolios as recited in claim 7, wherein said cover has an edge and said means to secure further includes a flap member extending from said edge.

10. The customized cover for binders, folders and portfolios as recited in claim 9, wherein said flap has a length substantially coincident with the length of said securing strap.

11. The customized cover for binders, folders and portfolios as recited in claim 4, wherein said cover has a front exterior surface and wherein said means to secure includes a hook and loop fastener disposed on said front exterior surface.

12. The customized cover for binders, folders and portfolios as recited in claim 11, wherein said cover has an edge and said means to secure further includes a flap member extending from said edge, and further including a hook and loop fastener disposed on said flap member.
